(19) United States
(12) Patent Application Publication
(10) Pub. No.: US 2021/0125039 A1
(43) Pub. Date: Apr. 29, 2021

(54) ACTION LEARNING DEVICE, ACTION LEARNING METHOD, ACTION LEARNING SYSTEM, PROGRAM, AND STORAGE MEDIUM

(71) Applicant: NEC Solution Innovators, Ltd., Koto-ku, Tokyo (JP)

(72) Inventors: Yoshihito MIYAUCHI, Tokyo (JP); Akio UDA, Tokyo (JP)

(73) Assignee: NEC Solution Innovators, Ltd., Koto-ku, Tokyo (JP)

(21) Appl. No.: 17/042,615

(22) PCT Filed: Jun. 7, 2019
(86) PCT No.: PCT/JP2019/022781

§ 371 Date: Sep. 28, 2020

(30) Foreign Application Priority Data
Jun. 11, 2018 (JP) 2018-110767
Dec. 17, 2018 (JP) 2018-235204

(51) Int. Cl. G06N 3/04; G06N 3/08

(52) U.S. Cl. CPC G06N 3/0481; G06N 3/08

(57) ABSTRACT

An action learning device includes an action candidate acquisition unit that extracts a plurality of possible action candidates based on situation information data representing an environment and a situation of a subject, a score acquisition unit that acquires a score that is an index representing an effect expected for a result caused by an action for each of the plurality of action candidates, an action selection unit that selects an action candidate having the largest score from the plurality of action candidates, and a score adjustment unit that adjusts a value of the score linked to the selected action candidate based on a result of the selected action candidate being performed on the environment.

### TECHNICAL FIELD

The present invention relates to an action learning device, an action learning method, an action learning system, a program, and a storage medium.

### BACKGROUND ART

In recent years, deep learning using a multilayer neural network has been paid attention to as a machine learning scheme. Deep learning uses a calculation scheme called backpropagation to calculate an output error when a large amount of training data is input to the multilayer neural network and perform learning so that the error is the smallest.

Patent Literatures 1 to 3 each disclose a neural network processing device that defines a large scale neural network as a combination of a plurality of subnetworks to enable construction of a neural network with less efforts and amount of computation. Further, Patent Literature 4 discloses a structure optimization device that optimizes a neural network.

### CITATION LIST

### Patent Literature

PTL 1: Japanese Patent Application Laid-Open No. 2001-051968

PTL 2: Japanese Patent Application Laid-Open No. 2002-251601

PTL 3: Japanese Patent Application Laid-Open No. 2003-317073

PTL 4: Japanese Patent Application Laid-Open No. H09-091263

### SUMMARY OF INVENTION

### Technical Problem

In deep learning, however, a large amount of high quality data is required as training data, and a long time is required for learning. Although a scheme for reducing efforts or amount of computation in constructing a neural network is proposed in Patent Literatures 1 to 4, an action learning device that can learn actions by using a simpler algorithm is desired for a further reduction in a system load or the like.

The present invention intends to provide an action learning device, an action learning method, an action learning system, a program, and a storage medium that may realize learning and selection of an action in accordance with an environment and a situation of a subject by using a simpler algorithm.

### Solution to Problem

According to one example aspect of the present invention, provided is an action learning device including an action candidate acquisition unit that extracts a plurality of possible action candidates based on situation information data representing an environment and a situation of a subject, a score acquisition unit that acquires a score that is an index representing an effect expected for a result caused by an action for each of the plurality of action candidates, an action selection unit that selects an action candidate having the largest score from the plurality of action candidates, and a score adjustment unit that adjusts a value of the score linked to the selected action candidate based on a result of the selected action candidate being performed on the environment.

Further, according to another example aspect of the present invention, provided is an action learning method including extracting a plurality of possible action candidates based on situation information data representing an environment and a situation of a subject, acquiring a score that is an index representing an effect expected for a result caused by an action for each of the plurality of action candidates, selecting an action candidate having the largest score from the plurality of action candidates, and adjusting a value of the score linked to the selected action candidate based on a result of the selected action candidate being performed on the environment.

Further, according to yet another example aspect of the present invention, provided is a non-transitory computer readable storage medium storing a program that causes a computer to function as a unit configured to extract a plurality of possible action candidates based on situation information data representing an environment and a situation of a subject, a unit configured to acquire a score that is an index representing an effect expected for a result caused by an action for each of the plurality of action candidates, a unit configured to select an action candidate having the largest score from the plurality of action candidates, and a unit configured to adjust a value of the score linked to the selected action candidate based on a result of the selected action candidate being performed on the environment.

### Advantageous Effects of Invention

According to the present invention, learning and selection of an action in accordance with an environment and a situation of a subject can be realized by a simpler algorithm.

### BRIEF DESCRIPTION OF DRAWINGS

FIG. 1 is a schematic diagram illustrating a configuration example of an action learning device according to a first example embodiment of the present invention.

FIG. 2 is a schematic diagram illustrating a configuration example of a score acquisition unit in the action learning device according to the first example embodiment of the present invention.

FIG. 3 is a schematic diagram illustrating a configuration example of a neural network unit in the action learning device according to the first example embodiment of the present invention.

FIG. 4 is a schematic diagram illustrating a configuration example of a learning cell in the action learning device according to the first example embodiment of the present invention.

FIG. 5 is a flowchart illustrating a learning method in the action learning device according to the first example embodiment of the present invention.

FIG. 6 is a diagram illustrating an example of situation information data generated by a situation information generation unit.

FIG. 7 is a diagram illustrating an example of situation information data and element values thereof generated by a situation information generation unit.

FIG. 8 is a schematic diagram illustrating a hardware configuration example of the action learning device according to the first example embodiment of the present invention.

FIG. 9 is a flowchart illustrating a learning method in an action learning device according to a second example embodiment of the present invention.

FIG. 10 is a schematic diagram illustrating a configuration example of an action learning device according to a third example embodiment of the present invention.

FIG. 11 is a flowchart illustrating a learning method in the action learning device according to the third example embodiment of the present invention.

FIG. 12 is a schematic diagram illustrating a configuration example of an action learning device according to a fourth example embodiment of the present invention.

FIG. 13 is a flowchart illustrating a method of generating know-how in the action learning device according to the fourth example embodiment of the present invention.

FIG. 14 is a schematic diagram illustrating an example of representation change in the action learning device according to the fourth example embodiment of the present invention.

FIG. 15 is a diagram illustrating a method of aggregating representation data in the action learning device according to the fourth example embodiment of the present invention.

FIG. 16 is a diagram illustrating an example of aggregated data in the action learning device according to the fourth example embodiment of the present invention.

FIG. 17 illustrates an example of aggregated data of positive scores and aggregated data of negative scores that indicate the same event.

FIG. 18 is a schematic diagram illustrating a method of organizing of an inclusion relationship of aggregated data in the action learning device according to the fourth example embodiment of the present invention.

FIG. 19 is a list of aggregated data extracted as know-how by the action learning device according to the fourth example embodiment of the present invention.

FIG. 20 is a schematic diagram illustrating a configuration example of an action learning device according to a fifth example embodiment of the present invention.

### DESCRIPTION OF EMBODIMENTS

### First Example Embodiment

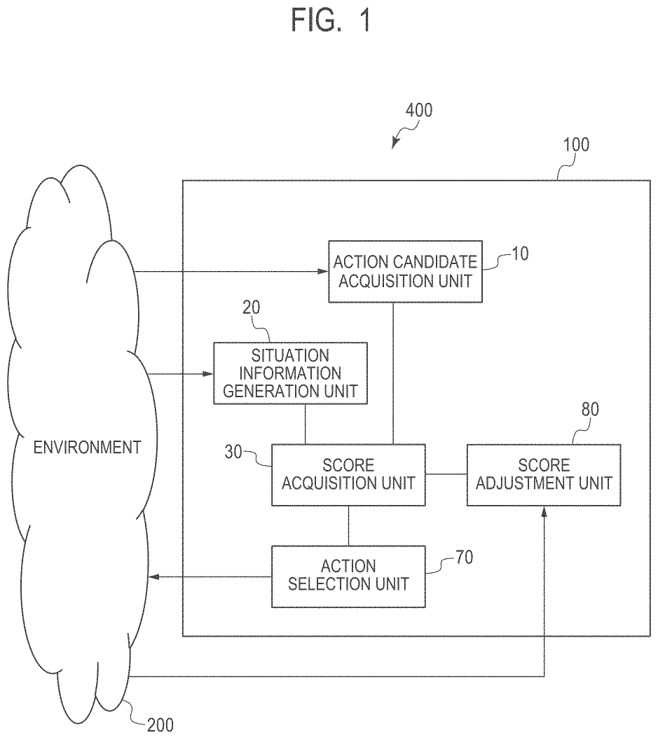

An action learning device and an action learning method according to a first example embodiment of the present invention will be described with reference to FIG. 1 to FIG. 8.

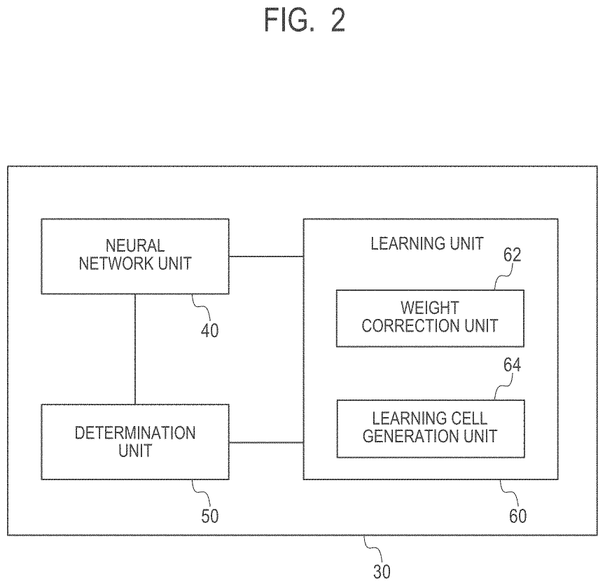

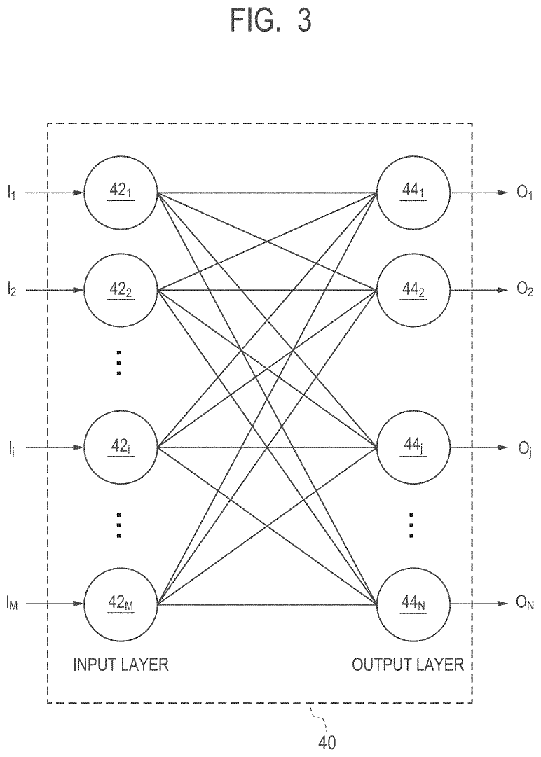

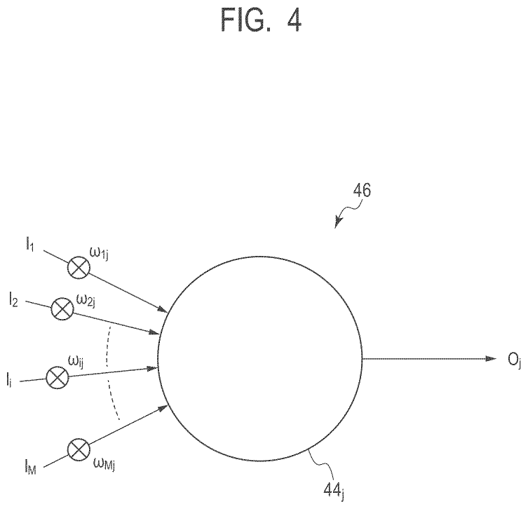

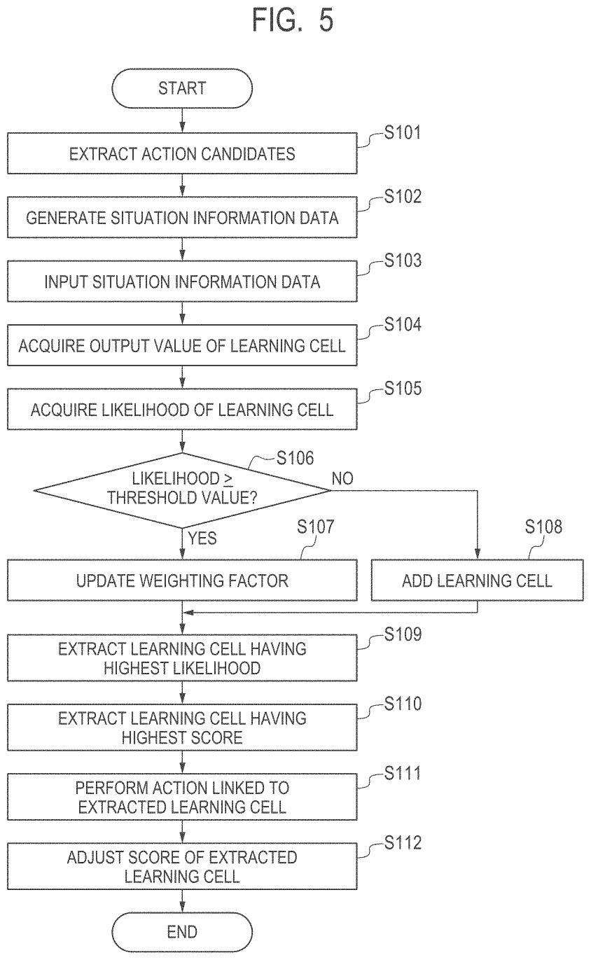

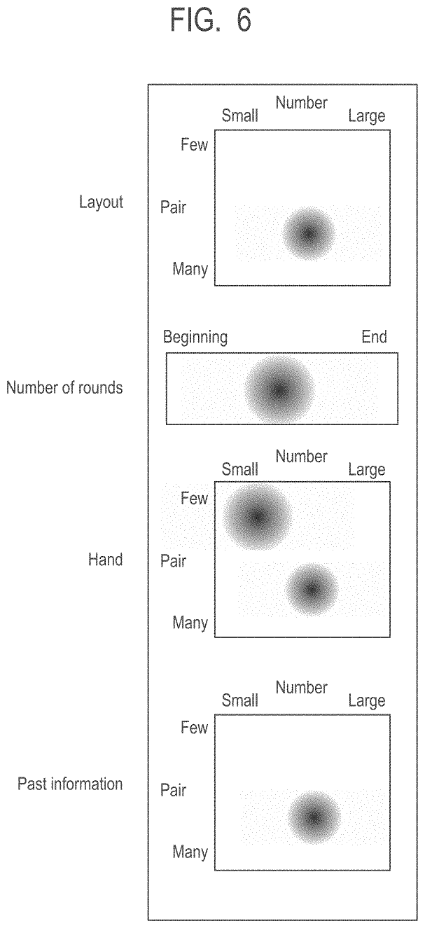

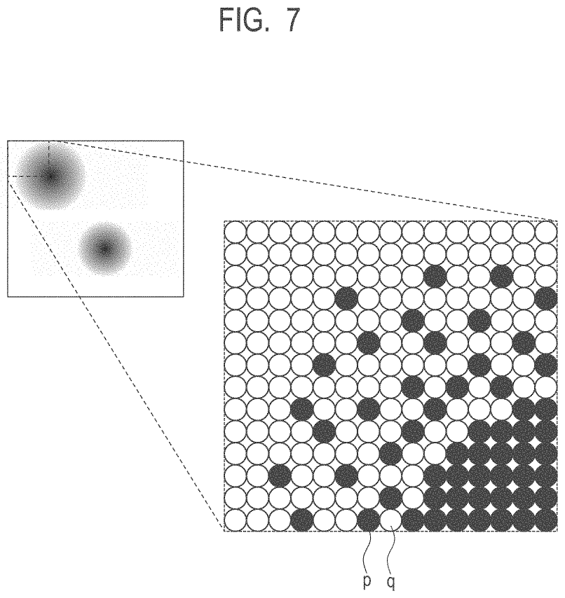

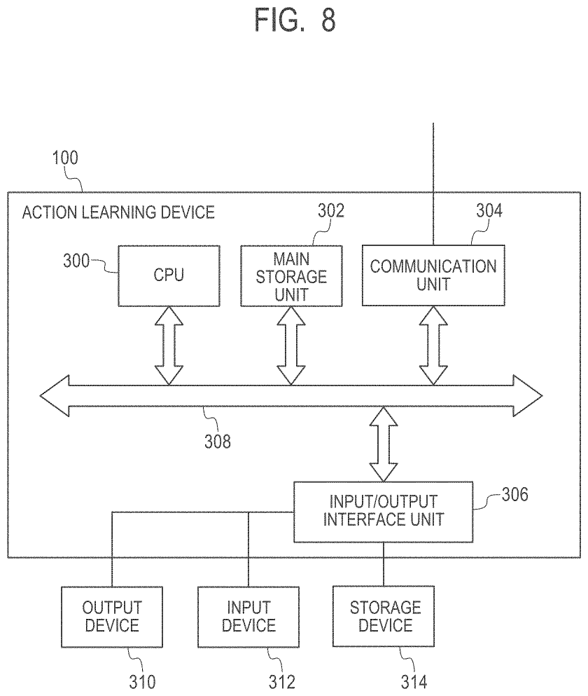

FIG. 1 is a schematic diagram illustrating a configuration example of the action learning device according to the present example embodiment. FIG. 2 is a schematic diagram illustrating a configuration example of a score acquisition unit in the action learning device according to the present example embodiment. FIG. 3 is a schematic diagram illustrating a configuration example of a neural network unit in the action learning device according to the present example embodiment. FIG. 4 is a schematic diagram illustrating a configuration example of a learning cell in the action learning device according to the present example embodiment. FIG. 5 is a flowchart illustrating the action learning method in the action learning device according to the present example embodiment. FIG. 6 is a diagram illustrating an example of situation information data. FIG. 7 is a diagram illustrating an example of situation information data and element values thereof. FIG. 8 is a schematic diagram illustrating a hardware configuration example of the action learning device according to the present example embodiment.

First, a general configuration of the action learning device according to the present example embodiment will be described with reference to FIG. 1 to FIG. 4.

As illustrated in FIG. 1, an action learning device 100 according to the present example embodiment has an action candidate acquisition unit 10, a situation information generation unit 20, a score acquisition unit 30, an action selection unit 70, and a score adjustment unit 80. The action learning device 100 performs learning based on information received from an environment 200 and decides an action to be performed for the environment. That is, the action learning device 100 forms an action learning system 400 together with the environment 200.

The action candidate acquisition unit 10 has a function that, based on information received from the environment 200 and a situation of a subject (agent), extracts action(s) that may be taken under the situation (action candidate). Note that the agent refers to a subject who performs learning and selects an action. The environment refers to a target which an agent works on.

The situation information generation unit 20 has a function that, based on information received from the environment 200 and a situation of a subject, generates situation information data representing information related to an action. The information included in the situation information data is not particularly limited as long as it is related to an action and may be, for example, environment information, time, the number of times, a subject state, the past action, or the like.

The score acquisition unit 30 has a function that acquires a score for situation information data generated by the situation information generation unit 20 for each of the action candidates extracted by the action candidate acquisition unit 10. Herein, the score refers to a variable used as an index representing an effect expected for a result caused by an action. For example, the score is higher when the evaluation of a result caused by an action is expected to be higher, and the score is lower when the evaluation of a result caused by action is expected to be lower.

The action selection unit 70 has a function that, out of action candidates extracted by the action candidate acquisition unit 10, selects an action candidate whose score acquired by the score acquisition unit 30 is the highest and performs the selected action on the environment 200.

The score adjustment unit 80 has a function that, in accordance with a result provided to the environment 200 by an action selected by the action selection unit 70, adjusts the value of a score linked to the selected action. For example, the score is increased when the evaluation of a result caused by an action is high, and the score is reduced when the evaluation of a result caused by an action is low.

In the action learning device 100 according to the present example embodiment, the score acquisition unit 30 includes a neural network unit 40, a determination unit 50, and a learning unit 60, as illustrated in FIG. 2, for example. The learning unit 60 includes a weight correction unit 62 and a learning cell generation unit 64.

The neural network unit 40 may be formed of a two-layer artificial neural network including an input layer and an output layer, as illustrated in FIG. 3, for example. The input layer has cells (neuron) 42, the number of which corresponds to the number of element values extracted from single situation information data. For example, when single situation information data includes M element values, the input layer includes at least M cells 42₁, 42₂, . . . , 42ᵢ, . . . , and 42_{M}. The output layer has cells (neuron) 44, the number of which corresponds to at least the number of actions that may be taken. For example, the output layer includes at least N cells 44₁, 44₂, . . . , 44ⱼ, . . . , and 44_{N}. Each of the cells 44 forming the output layer is linked to any of the actions that may be taken. Further, a predetermined score is set for each of the cells 44.

M element values I₁, I₂, . . . , Iᵢ, . . . , and I_{M} of situation information data are input to the cells 42₁, 42₂, . . . , 42ᵢ, . . . , and 42_{M} of the input layer, respectively. Each of the cells 42₁, 42₂, . . . , 42ᵢ, . . . , and 42_{M} outputs the input element value I to the cells 44₁, 44₂, . . . , 44ⱼ, . . . , and 44_{N}, respectively.

A weighting factor ω for performing predetermined weighting on the element value I is set for each of branches (axon) that connect the cells 42 to the cells 44. For example, weighting factors ω₁ⱼ, ω₂ⱼ, . . . , and ω_{Mj} are set for branches that connect the cells 42₁, 42₂, . . . , 42ᵢ, . . . , and 42_{M} to the cell 44ⱼ, as illustrated in FIG. 4, for example. Thereby, the cell 44ⱼ performs calculation represented by the following Equation (1) and outputs an output value Oⱼ.

$$[ Math . 1 ]$$

$${Q}_{j} = {\sum }_{i = 1}^{M} {ω}_{ij} \times {I}_{i} \qquad ( 1 )$$

Note that, in the present specification, one cell 44, branches (input nodes) that input the element values I₁ to I_{M} to the cell 44, and a branch (output node) that outputs an output value O from the cell 44 may be collectively denoted as a learning cell(s) 46.

The determination unit 50 compares a correlation value between a plurality of element values extracted from situation information data and an output value of a learning cell with a predetermined threshold value and determines whether the correlation value is greater than or equal to a threshold value or less than the threshold value. An example of the correlation value is a likelihood for the output value of a learning cell. Note that the function of the determination unit 50 may be included in each of the learning cells 46.

The learning unit 60 is a function block that trains the neural network unit 40 in accordance with a determination result in the determination unit 50. If the correlation value described above is greater than or equal to the predetermined threshold value, the weight correction unit 62 updates the weighting factor ω set to the input node of the learning cell 46. Further, if the correlation value described above is less than the predetermined threshold value, the learning cell generation unit 64 adds a new learning cell 46 to the neural network unit 40.

Next, the action learning method using the action learning device 100 according to the present example embodiment will be described with reference to FIG. 5 to FIG. 7. Note that, for easier understanding here, illustration will be supplemented as appropriate with an example of an action of a player in a card game “Daifugo (Japanese version of President)”. However, the action learning device 100 according to the present example embodiment can be widely applied to a use of selecting an action in accordance with a state of the environment 200.

First, based on information received from the environment 200 and a situation of a subject, the action candidate acquisition unit 10 extracts actions that may be taken under the situation (action candidates) (step S101). A method of extracting action candidates is not particularly limited, and extraction can be performed by using a program based on a rule, for example.

In the case of “Daifugo”, the information received from the environment 200 may be, for example, information on the type (for example, a single card or multiple cards) or the power of the card(s) on the field, information about whether or not another player has passed, or the like. The situation of the subject may be, for example, information on a hand, information on cards that have been discarded so far, information on the number of rounds, or the like. The action candidate acquisition unit 10 extracts all the actions that may be taken under the environment 200 and the situation of the subject described above (action candidates) in accordance with the rule of “Daifugo”. For example, when a hand includes a plurality of cards that are the same type as and stronger than the card(s) on the field, each of actions of discarding any of these plurality of cards is an action candidate. Further, passing his/her turn is one of the action candidates.

Next, it is checked whether or not each of the action candidates extracted by the action candidate acquisition unit 10 is linked to at least one learning cell 46 included in the neural network unit 40 of the score acquisition unit 30. When there is an action candidate not linked to the learning cell 46, a learning cell 46 linked to the action candidate of interest is newly added to the neural network unit 40. Note that, when all the actions that may be taken are known, the learning cell 46 linked to each of all the expected actions may be set in advance in the neural network unit 40.

Note that a predetermined score is set for each of the learning cells 46 as described above. When a learning cell 46 is added, an arbitrary value is set for the learning cell 46 as the initial value of the score. For example, when scores are set within a numerical range from −100 to +100, 0 may be set as the initial value of the score, for example.

Next, the situation information generation unit 20 generates situation information data in which information related to actions is mapped based on the information received from the environment 200 and the situation of the subject (step S102). The situation information data is not particularly limited and may be generated by representing information based on the environment or the situation of the subject as bitmap image data, for example. The generation of situation information data may be performed prior to step S101 or in parallel to step S101.

FIG. 6 is a diagram illustrating an example of situation information data that represents the layout, the number of rounds, the hand, and the past information as bitmap images out of information indicating the environment 200 and the situation of the subject. In FIG. 6, “Number” represented in the horizontal axis of each image indicated as “Layout”, “Hand”, and “Past information” represents the power of the card. That is, a smaller “Number” indicates a weaker card, and a larger “Number” indicates a stronger card. In FIG. 6, “Pair” represented in the vertical axis of each image indicated as “Layout”, “Hand”, and “Past information” represents the number of sets of cards. For example, in a Daifugo hand constituted of a single type of number, the value of “Pair” increases in the order of one card, two cards (a pair), three cards (three of a kind), and four cards (four of a kind). In FIG. 6, “Number of rounds” represents at what stage of the game the current turn is from the start to the end of one game in a two-dimensional manner in the horizontal axis direction. Note that, while blurring the boundary of each point in the illustrated plot is intended to improve generalization performance, the boundary of each point is not necessarily required be blurred.

For the mapping of situation information, processing such as hierarchization of and performing processing stepwise, conversion of information, combination of information, or the like while cutting out a part of information may be performed for the purpose of reduction of the processing time, reduction of the number of learning cells, improvement of accuracy of action selection, or the like.

FIG. 7 is a view in which a portion of “Hand” of the situation information data illustrated in FIG. 6 is extracted. For this situation information data, one pixel can be associated with one element value as illustrated in an enlarged view on the right side, for example. Further, the element value corresponding to a white pixel can be defined as 0, and the element value corresponding to a black pixel can be defined as 1. For example, in the example of FIG. 7, the element value Iₚ corresponding to the p-th pixel is 1, and the element value I_{q} corresponding to the q-th pixel is 0. The element values associated with one situation information data are the element values I₁ to I_{M}.

Next, the element values I₁ to I_{M} of the situation information data generated by the situation information generation unit 20 are input to the neural network unit 40 (step S103). The element values I₁ to I_{M} input to the neural network unit 40 are input to each of the learning cells 46 linked to the action candidates extracted by the action candidate acquisition unit 10 via the cells 42₁ to 42_{M}. Each of the learning cells 46 to which the element values I₁ to I_{M} are input outputs the output value O based on Equation (1). Accordingly, the output value O from the learning cells 46 for the element values I₁ to I_{M} is acquired (step S104).

When the learning cell 46 is in a state where no weighting factor ω is set for each input node, that is, the initial state where the learning cell 46 has not yet trained, the input element values I₁ to I_{M} are set as the initial values of the weighting factors ω at the input nodes of the learning cell 46. For example, in the example of FIG. 7, the weighting factor ωₚⱼ at the input node corresponding to the p-th pixel of the learning cell 46ⱼ is 1, and the weighting factor ω_{qj} at the input node corresponding to the q-th pixel of the learning cell 46ⱼ is 0. The output value O in such a case is calculated by using the weighting factors ω set as the initial values.

Next, at the determination unit 50, a correlation value between the element values I₁ to I_{M} and the output value O from the learning cell 46 (which is here defined as a likelihood P related to the output value of the learning cell) is acquired (step S105). A method of calculating the likelihood P is not particularly limited. For example, the likelihood Pⱼ of the learning cell 46ⱼ can be calculated based on the following Equation (2).

$$[ Math . 2 ]$$

$${P}_{j} = \frac{Σ ( {P}_{j} \times {ω}_{ij} )}{{Σω}_{ij}} \qquad ( 2 )$$

Equation (2) indicates that the likelihood P is represented by a ratio of the output value O of the learning cell 46ⱼ to the accumulated value of the weighting factor ωᵢⱼ at a plurality of input nodes of the learning cell 46g. Alternatively, it is indicated that the likelihood Pⱼ is represented by a ratio of the output value of the learning cell 46ⱼ when a plurality of element values are input to the largest value of the output of the learning cell 46j based on the weighting factor ωᵢⱼ at a plurality of input nodes.

Next, at the determination unit 50, the acquired value of the likelihood P is compared with a predetermined threshold value to determine whether or not the likelihood P is greater than or equal to the threshold value (step S106).

In each of the action candidates, if one or more learning cells 46 whose value of the likelihood P is greater than or equal to the threshold value is present in the learning cells 46 linked to the action candidate of interest (step S106, “Yes”), the process proceeds to step S107. In step S107, the weighting factors ω at the input nodes of the learning cell 46 having the largest value of the likelihood P out of the learning cells 46 linked to the action candidate of interest is updated. The weighting factor ωᵢⱼ at the input node of the learning cell 46ⱼ can be corrected based on the following Equation (3), for example.

ωᵢⱼ=(the number of occurrences of black in the i-th pixel)/(the number of times of learning) (3)

Equation (3) indicates that the weighting factor ω at each of the plurality of input nodes of the learning cell 46 is decided by an accumulated mean value of the element values I input from the corresponding input nodes. In such a way, information on situation information data in which the value of the likelihood P is greater than or equal to the predetermined threshold value is accumulated onto the weighting factor ω of each input node, and thereby, the value of the weighting factor ω is larger for an input node corresponding to a pixel having a larger number of occurrences of black (1). Such a learning algorithm of the learning cell 46 is an algorithm approximated to the Hebb's rule known as a learning principle of a human brain.

On the other hand, in each of the action candidates, if no learning cell 46 whose value of the likelihood P is greater than or equal to the threshold value is present in the learning cells 46 linked to the action candidate of interest (step S106, “No”), the process proceeds to step S108. In step S108, a new learning cell 46 linked to the action candidate of interest is generated. The element values I₁ to I_{M} are set as the initial values of the weighting factors ω to each input node of the newly generated learning cell 46 in the same manner as the case where the learning cell 46 is in the initial state. Further, an arbitrary value is set to the added learning cell 46 as the initial value of the score. In such a way, by adding the learning cell 46 linked to the same action candidate, it is possible to learn various forms of situation information data belonging to the same action candidate, and it is possible to select a more suitable action.

Note that addition of the learning cell 46 is not always required to be performed when no learning cell 46 whose value of the likelihood P is greater than or equal to the threshold value is present in any action candidate. For example, the learning cell 46 may be added only when no learning cell 46 whose value of the likelihood P is greater than or equal to the threshold value is present in any of all the action candidates. In such a case, the added learning cell 46 can be linked to any action candidate selected at random from a plurality of action candidates.

While the threshold value used in the determination of the likelihood P has a higher adaptability to situation information data for a larger the value of the threshold value, the number of learning cells 46 will be larger, and more time will be required for learning. In contrast, while the threshold value has a lower adaptability to situation information data for a smaller value of the threshold value, the number of learning cells 46 will be smaller, and time required for learning will be shorter. It is desirable to suitably set the setting value of the threshold value so that a desired adaptation rate or learning time is obtained in accordance with the type, the form, or the like of situation information data.

Next, in each of the action candidates, the learning cell 46 having the highest correlation (likelihood P) for situation information data is extracted from the learning cells 46 linked to the action candidate of interest (step S109).

Next, the learning cell 46 having the highest score is extracted from the learning cells 46 extracted in step S109 (step S110).

Next, at the action selection unit 70, an action candidate linked to the learning cell 46 having the highest score is selected, and the action is performed on the environment 200 (step S111). Accordingly, an action expected to achieve the highest evaluation of a result caused by the action can be performed on the environment 200.

Next, at the score adjustment unit 80, the score of the learning cell 46 extracted as the learning cell 46 having the highest score is adjusted based on evaluation of a result obtained by performing the action selected by the action selection unit 70 on the environment 200 (step S112). For example, the score is increased when the evaluation of the result caused by an action is high, and the score is reduced when the evaluation of the result caused by an action is low in step S112. With such adjustment of the score of the learning cell 46, the neural network unit 40 can proceed with learning so that the score is higher for the learning cell 46 which is expected to achieve a higher evaluation of a result when performed on the environment 200.

In the case of “Daifugo”, since it is difficult to evaluate a result from one action during one game, it is possible to adjust the score of the learning cell 46 based on the rank at the end of one game. For example, in a case of the first place, each score of the learning cell 46 extracted as the learning cell 46 having the highest score in each turn in the game is increased by 10. In a case of the second place, each score of the learning cell 46 extracted as the learning cell 46 having the highest score in each turn in the game is increased by 5. In a case of the third place, no adjustment of the score is performed. In a case of the fourth place, each score of the learning cell 46 extracted as the learning cell 46 having the highest score in each turn in the game is reduced by 5. In a case of the fifth place, each score of the learning cell 46 extracted as the learning cell 46 having the highest score in each turn in the game is reduced by 10.

With such a configuration, the neural network unit 40 can be trained based on situation information data. Further, situation information data is input to the neural network unit 40 in which learning is advanced, and thereby an action expected to achieve high evaluation of a result when performed on the environment 200 can be selected from a plurality of action candidates.

The learning method of the neural network unit 40 in the action learning device 100 according to the present example embodiment does not apply error backpropagation as used in deep learning or the like but enables training with a single path. Thus, the training process of the neural network unit 40 can be simplified. Further, since respective learning cells 46 are independent of each other, data is easily added, deleted, or updated. Further, it is possible to map and process any type of information, and this provides high versatility. Further, the action learning device 100 according to the present example embodiment is able to perform so-called dynamic learning and can easily perform an additional training process using situation information data.

Next, a hardware configuration example of the action learning device 100 according to the present example embodiment will be described with reference to FIG. 8. FIG. 8 is a schematic diagram illustrating the hardware configuration example of the action learning device according to the present example embodiment.

The action learning device 100 can be implemented by the same hardware configuration as that of a general information processing device, as illustrated in FIG. 8, for example. For example, the action learning device 100 has a central processing unit (CPU) 300, a main storage unit 302, a communication unit 304, and an input/output interface unit 306.

The CPU 300 is a control and calculation device that administers overall control and computation of the action learning device 100. The main storage unit 302 is a storage unit used for a working area of data or a temporal save area of data and is formed of a memory device such as a random access memory (RAM). The communication unit 304 is an interface used for transmitting and receiving data via a network. The input/output interface unit 306 is an interface used for being connected to an external output device 310, an external input device 312, an external storage device 314, or the like and transmitting and receiving data. The CPU 300, the main storage unit 302, the communication unit 304, and the input/output interface unit 306 are connected to each other by a system bus 308. The storage device 314 may be formed of a read only memory (ROM), a magnetic disk, a hard disk device formed of a nonvolatile memory such as a semiconductor memory, or the like, for example.

The main storage unit 302 can be used as a working area used for constructing the neural network unit 40 including the plurality of learning cells 46 and executing calculation. The CPU functions as a control unit that controls computation in the neural network unit 40 constructed in the main storage unit 302. In the storage device 314, learning cell information including information related to a trained learning cell 46 can be stored. Further, it is possible to construct a learning environment for various situation information data by reading the learning cell information stored in the storage device 314 and constructing the neural network unit 40 in the main storage unit 302. It is desirable that the CPU 300 be configured to perform computation in parallel in the plurality of learning cells 46 of the neural network unit 40 constructed in the main storage unit 302.

The communication unit 304 is a communication interface based on a specification such as Ethernet (registered trademark), Wi-Fi (registered trademark), or the like and is a module used for communicating with another device. The learning cell information may be received from another device via the communication unit 304. For example, learning cell information which is frequently used may be stored in the storage device 314 in advance, and learning cell information which is less frequently used may be read from another device.

The input device 312 is a keyboard, a mouse, a touch panel, or the like and is used by the user for inputting predetermined information in the action learning device 100. The output device 310 includes a display such as a liquid crystal device, for example. Notification of a learning result may be performed via the output device 310.

The situation information data may be read from another device via the communication unit 304. Alternatively, the input device 312 can be used as a component by which the situation information data is input.

The function of each unit of the action learning device 100 according to the present example embodiment can be implemented in a hardware-like manner by mounting circuit components that are hardware components such as large scale integration (LSI) in which a program is embedded. Alternatively, software-like implementation is also possible by storing a program providing the function in the storage device 314, loading the program into the main storage unit 302, and executing the program by the CPU 300.

As described above, according to the present example embodiment, learning and selection of an action in accordance with an environment and a situation of a subject can be realized by a simpler algorithm.

### Second Example Embodiment

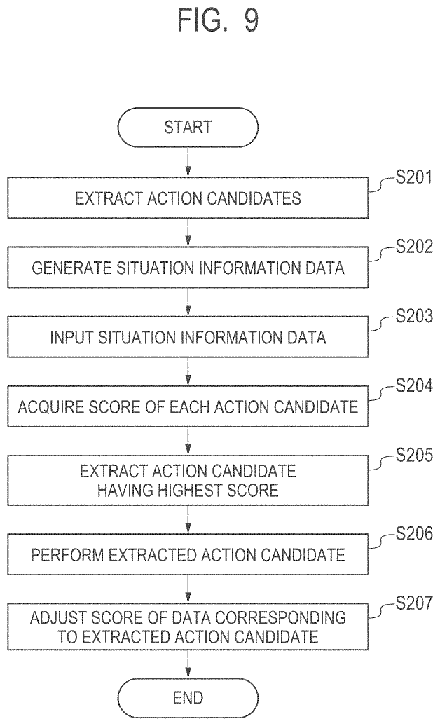

An action learning device and an action learning method according to a second example embodiment of the present invention will be described with reference to FIG. 9. The same components as those in the action learning device according to the first example embodiment are labeled with the same references, and the description thereof will be omitted or simplified.

The basic configuration of the action learning device according to the present example embodiment is the same as the action learning device according to the first example embodiment illustrated in FIG. 1. The action learning device according to the present example embodiment is different from the action learning device according to the first example embodiment in that the score acquisition unit 30 is formed of a database. The action learning device according to the present example embodiment will be described below with reference to FIG. 1 mainly for the feature different from the action learning device according to the first example embodiment.

The situation information generation unit 20 has a function of generating situation information data that is a key for searching a database based on information received from the environment 200 and a situation of a subject. The situation information data is not required to perform mapping as with the case of the first example embodiment, and the information received from the environment 200 or the situation of the subject can be applied thereto without change. For example, in the example of “Daifugo”, the card in the field, the number of rounds, the hand, the past information, or the like described above can be used as a key used for performing searching.

The score acquisition unit 30 has a database that provides a score for a particular action by using situation information data as a key. The database of the score acquisition unit 30 holds scores for all the expected actions for any combinations of situation information data. By using the situation information data generated by the situation information generation unit 20 as a key to search the database of the score acquisition unit 30, it is possible to acquire a score for each of the action candidates extracted by the action candidate acquisition unit 10.

The score adjustment unit 80 has a function of adjusting the values of scores registered in the database of the score acquisition unit 30 in accordance with a result provided to the environment 200 by the action selected by the action selection unit 70. With such a configuration, it is possible to train the database of the score acquisition unit 30 based on a result caused by an action.

Next, the action learning method using the action learning device according to the present example embodiment will be described with reference to FIG. 9.

First, based on information received from the environment 200 and a situation of a subject, the action candidate acquisition unit 10 extracts actions that may be taken under the situation (action candidates) (step S201). A method of extracting action candidates is not particularly limited, and extraction can be performed based on a rule registered in the rule base, for example.

Next, the situation information generation unit 20 generates situation information data representing information related to actions based on the information received from the environment 200 and the situation of the subject (step S202). The generation of situation information data may be performed prior to step S201 or in parallel to step S201.

Next, the situation information data generated by the situation information generation unit 20 is input to the score acquisition unit 30 (step S203). The score acquisition unit 30 uses the input situation information data as a key to search the database and acquires a score for each of the action candidates extracted by the action candidate acquisition unit 10 (step S204).

Next, at the action selection unit 70, an action candidate having the highest score acquired by the score acquisition unit 30 is extracted from the action candidates extracted by the action candidate acquisition unit 10 (step S205), and the action is performed on the environment 200 (step S206). Accordingly, an action expected to achieve the highest evaluation of a result caused by the action can be performed on the environment 200.

Next, at the score adjustment unit 80, the value of the score registered in the database of the score acquisition unit 30 is adjusted based on evaluation of a result obtained by performing the action selected by the action selection unit 70 on the environment 200 (step S207). For example, the score is increased when the evaluation of the result caused by an action is high, and the score is reduced when the evaluation of the result caused by an action is low. With the adjustment of the score in the database in such a way, the database of the score acquisition unit 30 can be trained based on a result caused by an action.

As described above, according to the present example embodiment, also when the score acquisition unit 30 is formed of a database, learning and selection of an action in accordance with an environment and a situation of a subject can be realized by a simpler algorithm as with the case of the first example embodiment.

### Third Example Embodiment

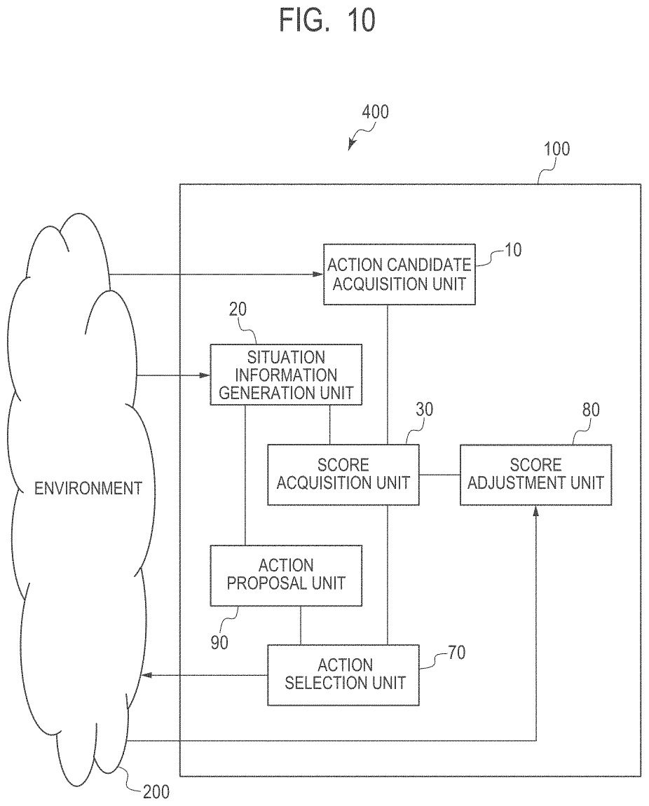

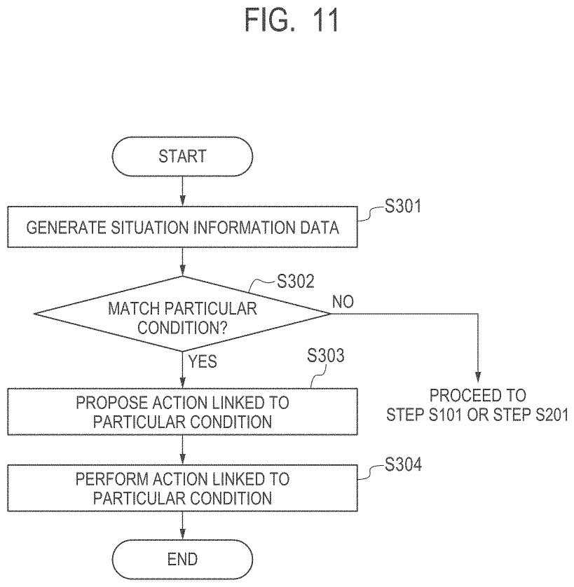

An action learning device and an action learning method according to a third example embodiment of the present invention will be described with reference to FIG. 10 and FIG. 11. The same components as those in the action learning device according to the first and second example embodiments are labeled with the same references, and the description thereof will be omitted or simplified. FIG. 10 is a schematic diagram illustrating a configuration example of the action learning device according to the present example embodiment. FIG. 11 is a flowchart illustrating the action learning method in the action learning device according to the present example embodiment.

The action learning device 100 according to the present example embodiment is the same as the action learning device according to the first or second example embodiment except for further having an action proposal unit 90, as illustrated in FIG. 10.

The action proposal unit 90 has a function that, when information received from the environment 200 and a situation of a subject satisfy a particular condition, proposes a particular action in accordance with the particular condition to the action selection unit 70. Specifically, the action proposal unit 90 has a database storing actions to be taken in a particular condition. The action proposal unit 90 uses information received from the environment 200 and a situation of a subject as a key to search the database. If the information received from the environment 200 and the situation of the subject matches a particular condition registered in the database, the action proposal unit 90 reads an action associated with the particular condition from the database and proposes the action to the action selection unit 70. The action selection unit 70 has a function that, when there is a proposal of an action from the action proposal unit 90, performs the action proposed by the action proposal unit 90 with priority.

The action proposed by the action proposal unit 90 may be an action belonging to so-called know-how. For example, in the example of “Daifugo”, 1) choosing an option made up of the largest number of cards in the candidates, 2) not choosing a strong option in the early stage, 3) choosing discard 8 from the early stage if no strong card is in the hand, 4) calling a revolution if the hand is weak, or the like may be considered. Note that discard 8 refers to a rule that, when a card of number 8 is included in the discarded card, the cards in the field may be flushed.

As one of the hypotheses describing human consciousness, a so-called passive consciousness hypothesis is known. The passive consciousness hypothesis is based on the idea that unconsciousness comes first and consciousness merely receives an ensuing result later. When taking a recognition architecture based on this passive consciousness hypothesis into consideration, it is possible to assume that “situation learning” corresponds to “unconsciousness” and “episode generation” corresponds to “consciousness”.

The situation learning as used herein is to adjust and learn an action so as to obtain the highest remuneration based on an environment, a result of previous actions, or the like. Such an operation is considered to correspond to a learning algorithm described in the first example embodiment or a learning algorithm in deep reinforcement learning. The episode generation is to establish a hypothesis and strategy from collected information, idea, or knowledge, inspect the hypothesis and strategy, and encourage reconsideration in situation learning if necessary. An example of the episode generation may be to perform an action based on knowledge accumulated as know-how. That is, it can be considered that the operation in which the action proposal unit 90 proposes an action to the action selection unit 70 in the action learning device in the present example embodiment corresponds to the episode generation.

Next, the action learning method using the action learning device according to the present example embodiment will be described with reference to FIG. 11.

First, the situation information generation unit 20 generates situation information data indicating information related to an action based on information received from the environment 200 and a situation of a subject (step S301).

Next, the action proposal unit 90 uses the situation information data generated by the situation information generation unit 20 as a key to search the database and determines whether or not the environment 200 and the situation of the subject satisfy a particular condition (step S302). In the example of “Daifugo”, the particular condition may be that a Daifugo hand constituted of multiple cards is included in eligible cards, that the game is in an early stage, that no strong card in the hand but a card of number 8 is included in the eligible cards, that the hand is weak but four of a kind are included in eligible cards, or the like.

As a result of determination, if the environment 200 and the situation of the subject do not satisfy the particular condition (step S302, “NO”), the process proceeds to step S101 of FIG. 5 or step S201 of FIG. 9 in accordance with the configuration of the score acquisition unit 30.

As a result of determination, if the environment 200 and the situation of the subject satisfy the particular condition (step S302, “YES”), the process proceeds to step S303. In step S303, the action proposal unit 90 proposes an action linked to the particular condition to the action selection unit 70.

Next, the action selection unit 70 performs the action proposed by the action proposal unit 90 on the environment 200 (step S304). In the example of “Daifugo”, the action linked to the particular condition may be to choose an option made up of the largest number of cards in the candidates, not choose a strong option, cheese discard 8, call a revolution, or the like.

With such a configuration, it is possible to select a more suitable action in accordance with the past memory or experience, and a higher evaluation result can be expected in the action performed on the environment 200.

Next, a result of learning and playing games performed will be described by using an existing game program of “Daifugo” in order to inspect the advantageous effect of the present invention.

The inspection of the advantageous effect of the present invention was performed in the following procedure. First, five clients having the learning algorithm of the action learning device of the present invention were prepared, and learning was performed by letting these five clients play games against each other. Next, four clients on the game program and one trained client played games against each other and were ranked. Specifically, 100 games were defined as one set, and the totals were ranked on a set basis. This was performed for 10 sets, and the mean of the ranks for 10 sets was defined as the final rank. Games for ranking were performed after 0 time, 100 times, 1000 times, 10000 times, and 15000 times of learning were performed, respectively.

Table 1 and Table 2 are tables illustrating results of inspection of the advantageous effect of the present invention by using the game program of “Daifugo”. Table 1 illustrates the inspection result in the action learning device according to the first example embodiment, and Table 2 illustrates the inspection result in the action learning device according to the present example embodiment. The four conditions described above as the example of know-how were set for action proposed by the action proposal unit 90. Table 1 and Table 2 indicate the number of training columns and the number of training discarded cards for references. The number of training discarded cards is the number of actions that may be taken.

TABLE 1

| Number | | | | | | | | Number |
|---|---|---|---|---|---|---|---|---|
| of | | | | | | | Number | of |
| games | | | | | | Aver- | of | training |
| during | 1st | 2nd | 3rd | 4th | 5th | age | training | discarded |
| training | place | place | place | place | place | rank | columns | cards |
| 0 | 0 | 0 | 0 | 1 | 9 | 4.9 | 0 | 0 |
| 100 | 1 | 0 | 1 | 2 | 6 | 4.2 | 875 | 169 |
| 1000 | 0 | 1 | 0 | 1 | 8 | 4.6 | 8794 | 290 |
| 10000 | 0 | 1 | 1 | 1 | 7 | 4.4 | 104185 | 293 |
| 15000 | 2 | 1 | 0 | 0 | 7 | 3.9 | 154356 | 285 |

TABLE 2

| Number | | | | | | | | Number |
|---|---|---|---|---|---|---|---|---|
| of | | | | | | | Number | of |
| games | | | | | | Aver- | of | training |
| during | 1st | 2nd | 3rd | 4th | 5th | age | training | discarded |
| training | place | place | place | place | place | rank | columns | cards |
| 0 | 6 | 1 | 1 | 0 | 2 | 2.1 | 0 | 0 |
| 100 | 5 | 1 | 2 | 0 | 2 | 2.3 | 875 | 169 |
| 1000 | 6 | 1 | 2 | 0 | 1 | 1.9 | 8794 | 290 |
| 10000 | 6 | 2 | 1 | 1 | 0 | 1.7 | 104185 | 293 |
| 15000 | 8 | 1 | 1 | 0 | 0 | 1.3 | 154356 | 285 |

As illustrated in Table 1 and Table 2, it is found that, by increasing the number of games during training, it is possible to improve the average rank in the example aspects of both the example embodiments. In particular, according to the example aspect of the present example embodiment, it was verified that the average rank can be significantly improved.

As described above, according to the present example embodiment, learning and selection of an action in accordance with an environment and a situation of a subject can be realized by a simpler algorithm. Further, with a configuration to, in a particular condition, propose a predetermined action in accordance with the particular condition, a more suitable action can be selected.

### Fourth Example Embodiment

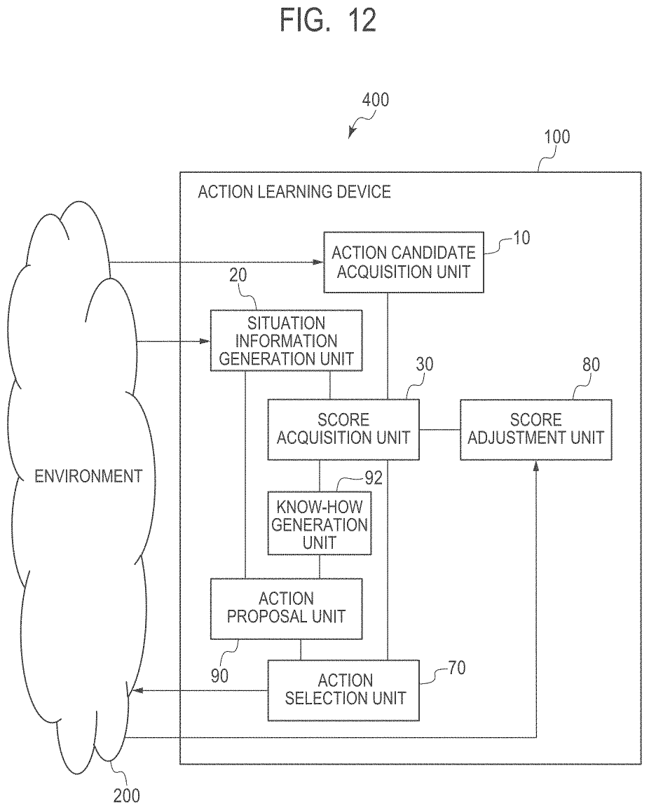

An action learning device according to a fourth example embodiment of the present invention will be described with reference to FIG. 12 to FIG. 19. The same components as those in the action learning device according to the first to third example embodiments are labeled with the same references, and the description thereof will be omitted or simplified.

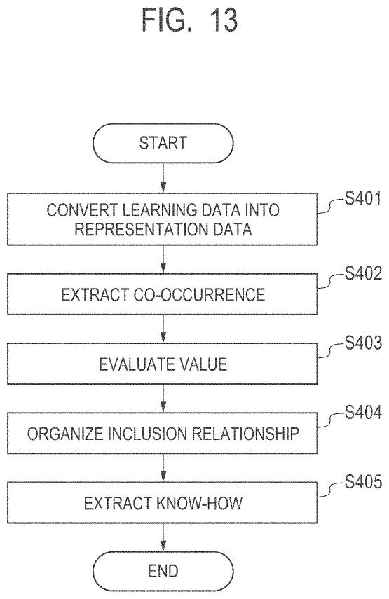

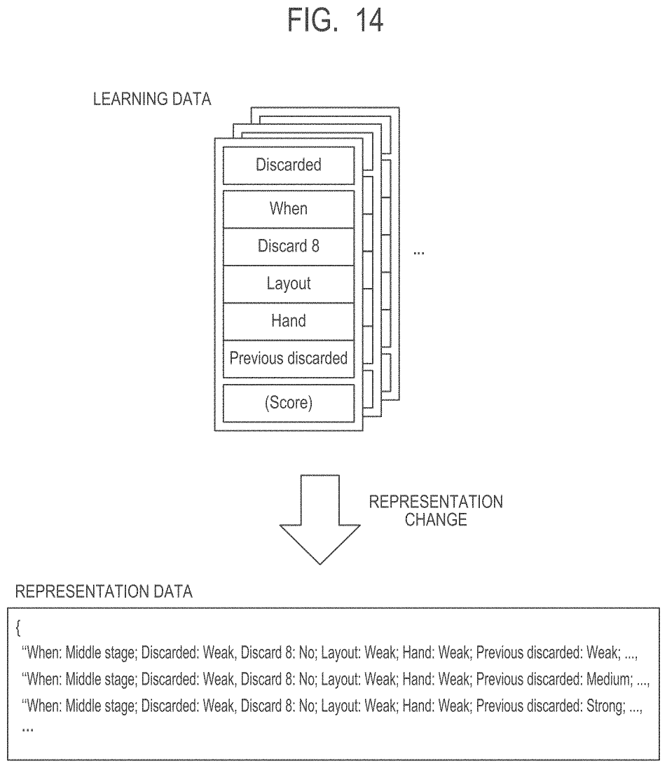

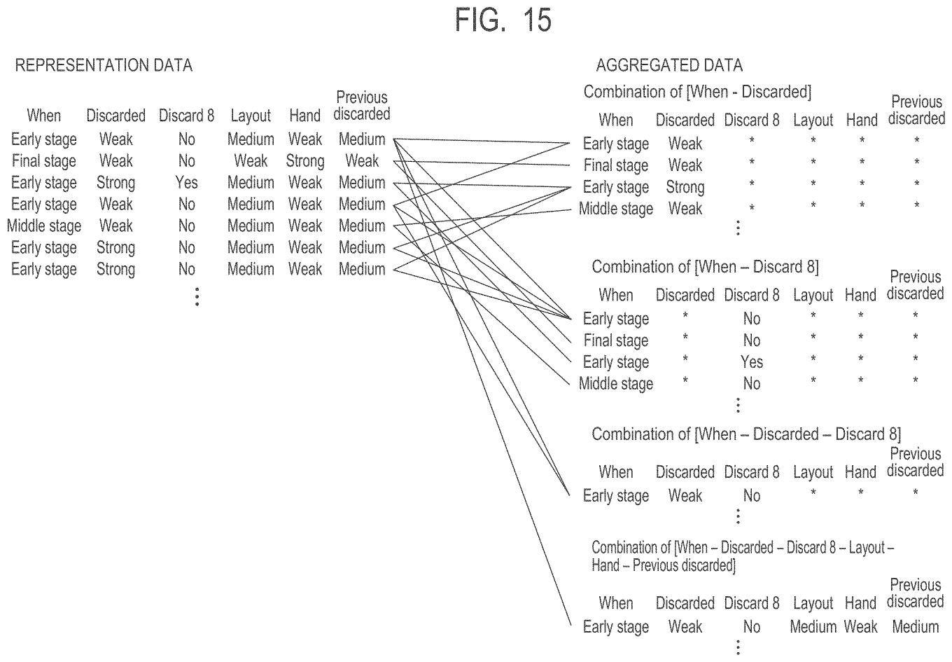

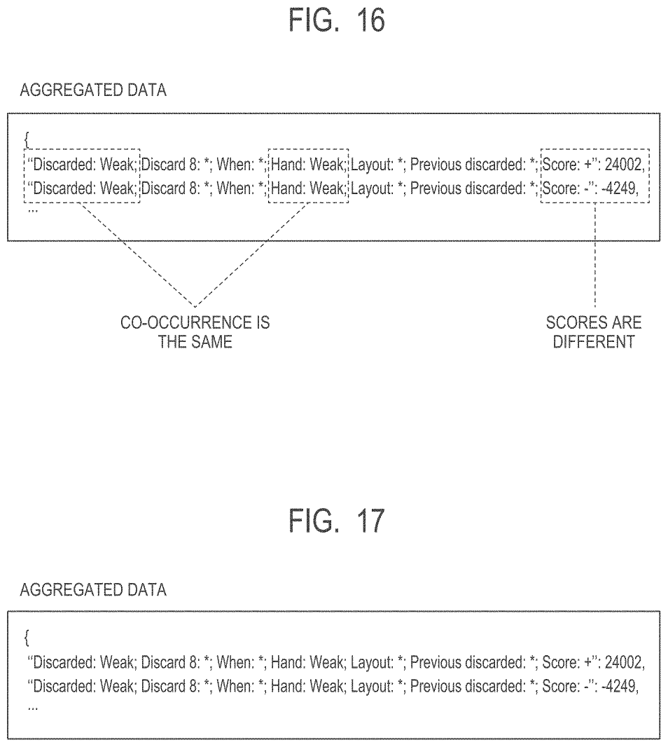

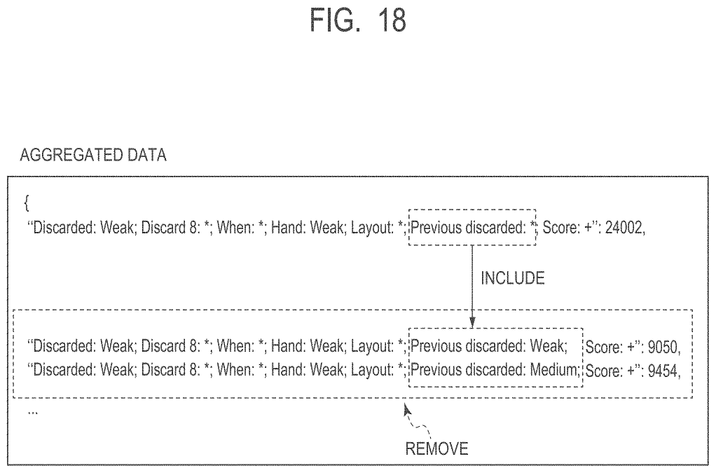

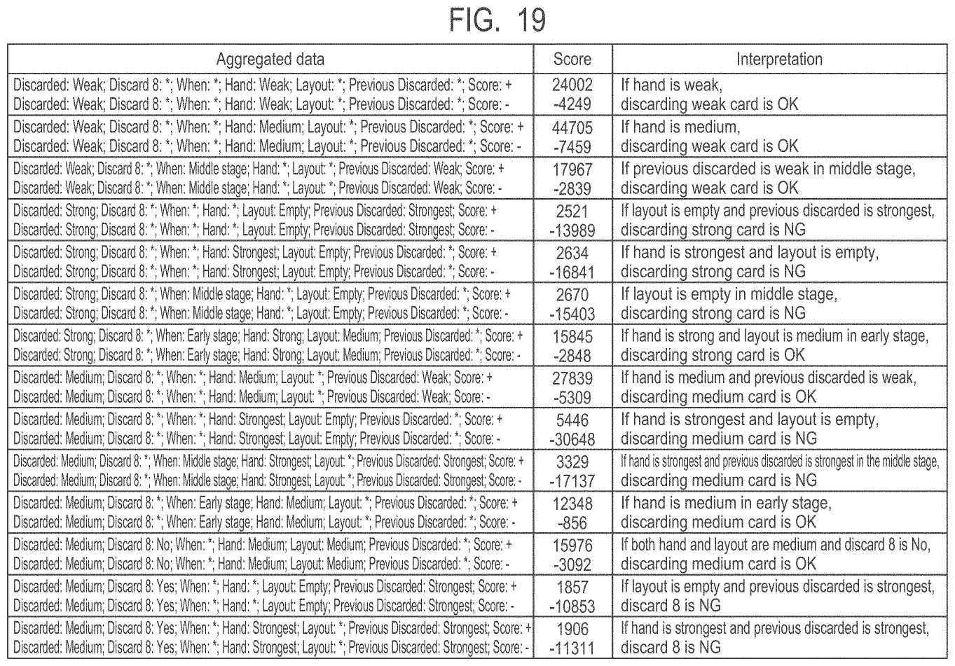

FIG. 12 is a schematic diagram illustrating a configuration example of an action learning device according to the present example embodiment. FIG. 13 is a flowchart illustrating a method of generating know-how in the action learning device according to the present example embodiment. FIG. 14 is a schematic diagram illustrating an example of representation change in the action learning device according to the present example embodiment. FIG. 15 is a diagram illustrating a method of aggregating representation data in the action learning device according to the present example embodiment. FIG. 16 is a diagram illustrating an example of aggregated data in the action learning device according to the present example embodiment. FIG. 17 illustrates an example of aggregated data of positive scores and aggregated data of negative scores that indicate the same event. FIG. 18 is a schematic diagram illustrating a method of organizing of an inclusion relationship of aggregated data in the action learning device according to the present example embodiment. FIG. 19 is a list of aggregated data extracted as know-how by the action learning device according to the present example embodiment.

The action learning device 100 according to the present example embodiment is the same as the action learning device according to the third example embodiment except for further having a know-how generation unit 92 as illustrated in FIG. 12.

The know-how generation unit 92 has a function of generating a list of actions that are advantageous to a particular condition (know-how) based on learning data accumulated by situation learning performed on the score acquisition unit 30. The list generated by the know-how generation unit 92 is stored in the database in the action proposal unit 90. If information received from the environment 200 and a situation of a subject match a particular condition registered in the database, the action proposal unit 90 reads an action associated with the particular condition from the database and proposes the action to the action selection unit 70. When there is a proposal of an action from the action proposal unit 90, the action selection unit 70 performs the action proposed by the action proposal unit 90 with priority. The operations of the action proposal unit 90 and the action selection unit 70 are the same as those in the case of the third example embodiment.

In such a way, the action learning device according to the present example embodiment finds a rule to provide an action which is expected to have high evaluation based on information, idea, or knowledge (learning data) accumulated in the score acquisition unit 30 and constructs a database included in the action proposal unit 90 based on the rule. Such an operation corresponds to generation of know-how from collected information in the “episode generation” described above.

Next, a know-how generation method in the action learning device according to the present example embodiment will be described with reference to FIG. 13 to FIG. 19.

First, the know-how generation unit 92 converts learning data accumulated in the score acquisition unit 30 by situation learning into representation data (step S401).

In the action learning device according to the first example embodiment, the learning data is information linked to each of the learning cells 46 included in the neural network unit 40 as a result of learning. A score obtained when a particular action is taken under a particular condition is set in each of the learning cells 46. Each learning data can be configured as data storing each of a particular condition, a particular action, or a score, as illustrated in FIG. 14, for example. Further, in the action learning device according to the second example embodiment, one learning data may be formed of a combination of a particular action, situation information data used as a key for searching for the particular action, and a score for the particular action, for example.

The representation change as used herein is to convert learning data into “word” based on representation change information. The representation change information is created based on sensible image that a person has for a state or behavior of learning data. The conversion table used in representation change is suitably set in accordance with the type of data or an action.

In the case of “Daifugo”, as illustrated in FIG. 14, six parameters of “When”, “Discarded” “Discard 8”, “Layout”, “Hand”, and “Previous discarded” can be selected as the representation change information, for example. For example, the parameter “When” can be set as a parameter representing whether it is “Early stage”, “Middle stage”, or “Final stage” in one game. The parameter “Discarded” can be set as a parameter representing whether the power of a card discarded by the subject is “Weak”, “Medium”, “Strong”, or “Strongest”. The parameter “Discard 8” can be set as a parameter representing whether or not discard 8 is available, namely, “Yes” or “No”. The parameter “Layout” can be set as a parameter representing whether the power of the card in the field is “Weak”, “Medium”, “Strong”, “Strongest”, or “Empty”. The parameter “Hand” can be set as a parameter representing whether the power of the hand is “Weak”, “Medium”, “Strong”, or “Strongest”. The parameter “Previous discarded” can be set as a parameter representing whether the power of the card previously discarded by the subject is “Weak”, “Medium”, “Strong”, or “Strongest”.

In representation change, data representing a particular condition and a particular action is replaced with a parameter selected as representation change information and the evaluation value thereof. For example, in the example of FIG. 14, the learning data of one learning cell 46 is converted as “When: Middle stage; Discarded: Weak; Discard 8: No; Layout: Weak; Hand: Weak; Previous discarded: Weak; . . . ”. Further, the learning data of another learning cell 46 is converted as “When: Middle stage; Discarded: Weak; Discard 8: No; Layout: Weak; Hand: Weak; Previous discarded: Middle; . . . ”.

Next, the know-how generation unit 92 extracts co-occurrence based on the representation data generated in step S401 (step S402).

In the extraction of co-occurrence, an advantageous event that appears frequently (has co-occurrence) is extracted. For method of extraction, an idea according to which a human views representation data and makes a decision may be referenced. Herein, a combination of respective elements is created, scores are aggregated (summed) on a combination basis, a combination having a high aggregated score is found, and thereby co-occurrence is extracted.

FIG. 15 illustrates an example of aggregating representation data in the example of “Daifugo” described above. In this example, data indicating the same event is collected for a combination of two or more parameters selected from six parameters of “When”, “Discarded” “Discard 8”, “Layout”, “Hand”, and “Previous discarded”. For example, for representation data indicating the event of [When: Early stage: Discarded: Strong], the third, sixth, and seventh representation data from the top are aggregated. Further, for representation data indicating the event of [When: Early stage: Discarded: Weak; Discard 8: No], the first and fourth representation data from the top are aggregated. In FIG. 15, the symbol “*” represents a wildcard.

The aggregation of scores of representation data indicating the same event is performed by classifying the representation data into a group of representation data indicating positive scores and a group of representation data indicating negative scores and accumulating scores of representation data in respective groups. The reason for classifying representation data indicating a positive score and representation data indicating a negative score is that, if these scores were simply accumulated, both the scores would be offset, and an accurate situation would not be recognized.

FIG. 16 illustrates an example of aggregated data in which representation data indicating an event [Discarded: Weak; Hand: Weak] are aggregated. The upper row represents aggregated data in which representation data indicating positive scores are aggregated, and the lower row represents aggregated data in which representation data indicating negative scores are aggregated.

Next, the know-how generation unit 92 performs value evaluation for each of the aggregated data generated in step S402 (step S403).

For example, the value evaluation of aggregated data can be performed in accordance with the relationship between aggregated data of positive scores and aggregated data of negative scores indicating the same event, the absolute value of a score, or the like.

It is considered that certain co-occurrence events having no significant difference between the positive score and the negative score have no suggestion as events and thus are unsuitable for a co-occurrence rule. Accordingly, such aggregated data is excluded from the candidates of know-how.

A criterion for determining whether or not there is a significant difference between a positive score and a negative score is not particularly limited and can be suitably set. For example, when the absolute value of a positive score is five times or greater the absolute value of a negative score, it can be determined that the aggregated data of positive scores has a high value as a candidate of know-how. In contrast, when the absolute value of a positive score is one-fifth or less the absolute value of a negative score, it can be determined that the aggregated data of negative scores has a high value as a candidate of know-how.

Further, it is considered that, even when a significant difference is recognized between a positive score and a negative score, the scores whose absolute value is relatively small have less implication as events. It is therefore desirable to exclude such aggregated data from the candidates of know-how. For example, only when the larger value of the absolute value of a positive score and the absolute value of a negative score is greater than or equal to 10000, the aggregated data thereof can be determined to be of a high value for a candidate of know-how.

FIG. 17 is an example of aggregated data of positive scores and aggregated data of negative scores indicating the same event. In this example, since the value of the positive score is 24002 and the value of the negative score is −4249, the absolute value of the positive score is more than five times greater than the absolute value of the negative score. Further, the absolute value of the positive score is greater than 10000. Therefore, according to the criterion described above, the set of these aggregated data can be determined to be of a high value for a candidate of know-how.

Note that the positive score linked to aggregated data represents that evaluation of a result of an action is high. That is, aggregated data of the positive scores indicates that the action is preferable as an action performed under the event. In contrast, the negative score linked to aggregated data represents that evaluation of a result of an action is low. That is, aggregated data of the negative scores indicates that the action is inappropriate as an action performed under the event.

Next, the know-how generation unit 92 organizes an inclusion relationship for aggregated data on which value evaluation has been performed in step S403 (step S404).

There is an event having an inclusion relationship in events having co-occurrence. Since a state where a large amount of aggregated data having an inclusion relationship are present is redundant resulting in a large amount of aggregated data, a process for removing the aggregated data on the included side and leaving only the aggregated data on the including side is performed.

For example, the aggregated data indicating the event of [Discarded: Weak; Hand: Weak] illustrated in the upper row of FIG. 18 includes the aggregated data indicating the event [Discarded: Weak; Hand: Weak; Previous discarded: Weak] and the aggregated data indicating the event [Discarded: Weak; Hand: Weak; Previous discarded: Medium] illustrated in the lower rows. Accordingly, in such a case, a process for removing two aggregated data indicated in the lower rows is performed in step S404.

Next, the know-how generation unit 92 extracts aggregated data of a high value from aggregated data organized in step S404 (step S405). The extracted aggregated data is stored in the database of the action proposal unit 90 as a list of know-how.

FIG. 19 is a list of aggregated data extracted as know-how in accordance with the procedure described above based on learning data extracted from the score acquisition unit 30 trained by performing 15000 games by using the existing game program of “Daifugo”. Note that the field of “Interpretation” in FIG. 19 is an example of representation data interpreted by a human with reference to know-how extracted in accordance with the procedure described above (co-occurrence know-how).

Next, a result of learning and playing games by using the existing game program of “Daifugo” for inspecting the advantageous effect of the present example embodiment will be described.

The inspection of the advantageous effect of the present invention was performed in the following procedure. First, five clients having the learning algorithm of the action learning device of the present invention were prepared, and learning was performed by letting these five clients play games against each other. Next, four clients on the game program and one trained client played games against each other and were ranked. Specifically, 100 games were defined as one set, and the totals were ranked on a set basis. This was performed for 10 sets, and the mean of the ranks for 10 sets was defined as the final rank. Games for ranking were performed after 0 time and 15000 times of learning were performed, respectively. Further, inspection was performed for the co-occurrence know-how (the present example embodiment), the dedicated know-how (the third example embodiment), and the dedicated know-how plus the co-occurrence know-how as the know-how proposed by the action proposal unit 90.

Table 3 is a table illustrating a result of inspection of the advantageous effect of the present invention by using the game program of “Daifugo”.

TABLE 3

| Number of times | | Average |
|---|---|---|
| of training | Know-how of episode generation | rank |
| 0 | No | 4.9 |
| 15000 | No | 3.9 |
| 15000 | Co-occurrence know-how | 2.9 |
| 15000 | Dedicated know-how | 1.3 |

As indicated in Table 3, it was verified that application of the co-occurrence know-how of the present example embodiment can improve the average rank compared to the case with no application of know-how. In particular, it was verified that a combined use of the co-occurrence know-how of the present example embodiment and the dedicated know-how described in the third example embodiment can significantly improve the average rank.

As described above, according to the present example embodiment, learning and selection of an action in accordance with an environment and a situation of a subject can be realized by a simpler algorithm. Further, with a configuration to, in a particular condition, propose a predetermined action in accordance with the particular condition, a more suitable action can be selected.

Note that, although the configuration in which the action learning device 100 has the know-how generation unit 92 has been described in the present example embodiment, the know-how generation unit 92 may be formed in a device other than the action learning device 100. For example, the example embodiment may be configured to read learning data from the score acquisition unit 30 to the external device, generate a list of know-how by using the know-how generation unit 92 formed in an external device, and load the generated list into the database of the action proposal unit 90.

### Fifth Example Embodiment

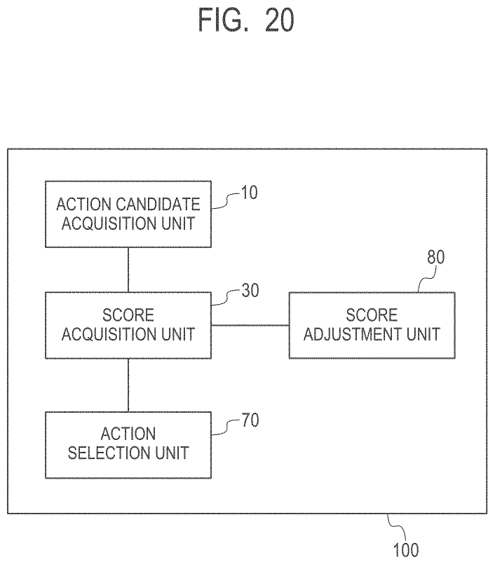

An action learning device according to a fifth example embodiment of the present invention will be described with reference to FIG. 20. The same components as those in the action learning device according to the first to fourth example embodiments are labeled with the same references, and the description thereof will be omitted or simplified. FIG. 20 is a schematic diagram illustrating a configuration example of the action learning device according to the present example embodiment.

As illustrated in FIG. 20, the action learning device 100 according to the present example embodiment has the action candidate acquisition unit 10, the score acquisition unit 30, the action selection unit 70, and the score adjustment unit 80.

Based on situation information data representing an environment and a situation of a subject, the action candidate acquisition unit 10 extracts a plurality of action candidates that can be taken. The score acquisition unit 30 acquires a score that is an index representing an effect expected for a result caused by an action for each of the plurality of action candidate. The action selection unit 70 selects an action candidate having the largest score from the plurality of action candidates. The score adjustment unit 80 adjusts a value of a score linked to the selected action candidate based on a result of the selected action candidate being performed on the environment 200.

With such a configuration, an action learning device that may realize learning and selection of an action in accordance with an environment and a situation of a subject with a simpler algorithm can be realized.

### Modified Example Embodiments

The present invention is not limited to the example embodiments described above, and various modifications are possible. For example, an example in which a part of the configuration of any of the example embodiments is added to another example embodiment or an example in which a part of the configuration of any of the example embodiments is replaced with a part of the configuration of another example embodiment is also one of the example embodiments of the present invention.

Further, although, in the example embodiments described above, the description has been provided with an example of actions in a player in a card game “Daifugo” as an application example of the present invention, the present invention can be widely applied to learning and selection of an action of a case where an action is made based on an environment and a situation of a subject.

Further, the scope of each of the example embodiments further includes a processing method that stores, in a storage medium, a program that causes the configuration of each of the example embodiments to operate so as to implement the function of each of the example embodiments described above, reads the program stored in the storage medium as a code, and executes the program in a computer. That is, the scope of each of the example embodiments also includes a computer readable storage medium. Further, each of the example embodiments includes not only the storage medium in which the computer program described above is stored but also the computer program itself.

As the storage medium, for example, a floppy (registered trademark) disk, a hard disk, an optical disk, a magneto-optical disk, a CD-ROM, a magnetic tape, a nonvolatile memory card, or a ROM can be used. Further, the scope of each of the example embodiments includes an example that operates on OS to perform a process in cooperation with another software or a function of an add-in board without being limited to an example that performs a process by a subject program stored in the storage medium.

All the example embodiments described above are mere illustrations of embodied examples in implementing the present invention, and the technical scope of the present invention should not be construed in a limiting sense by these example embodiments. That is, the present invention can be implemented in various forms without departing from the technical concept thereof or the primary feature thereof.

The whole or part of the example embodiments disclosed above can be described as, but not limited to, the following supplementary notes.

(Supplementary Note 1)

An action learning device comprising:

an action candidate acquisition unit that extracts a plurality of possible action candidates based on situation information data representing an environment and a situation of a subject;

a score acquisition unit that acquires a score that is an index representing an effect expected for a result caused by an action for each of the plurality of action candidates;

an action selection unit that selects an action candidate having the largest score from the plurality of action candidates; and

a score adjustment unit that adjusts a value of the score linked to the selected action candidate based on a result of the selected action candidate being performed on the environment.

(Supplementary Note 2)

The action learning device according to supplementary note 1,

wherein the score acquisition unit includes a neural network unit having a plurality of learning cells each including a plurality of input nodes that perform predetermined weighting on each of a plurality of element values based on the situation information data and an output node that sums and outputs the plurality of weighted element values,

wherein each of the plurality of learning cells has a predetermined score and is linked to any of the plurality of action candidates,

wherein the score acquisition unit sets, for a score of a corresponding action candidate, the score of a learning cell having the largest correlation value between the plurality of element values and an output value of the learning cell out of the learning cells linked to each of the plurality of action candidates,

wherein the action selection unit selects the action candidate having the largest score from the plurality of action candidates, and

wherein the score adjustment unit adjusts the score of the learning cell linked to the selected action candidate based on a result of the selected action candidate being performed.

(Supplementary Note 3)

The action learning device according to supplementary note 2,

wherein the score acquisition unit further includes a learning unit that trains the neural network unit, and

wherein the learning unit updates weighting factors of the plurality of input nodes of the learning cell in accordance with an output value of the learning cell or adds a new learning cell in the neural network unit.

(Supplementary Note 4)

The action learning device according to supplementary note 3, wherein the learning unit adds the new learning cell when a correlation value between the plurality of element values and an output value of the learning cell is less than a predetermined threshold value.

(Supplementary Note 5)

The action learning device according to supplementary note 3, wherein the learning unit updates the weighting factors of the plurality of input nodes of the learning cell when a correlation value between the plurality of element values and an output value of the learning cell is greater than or equal to a predetermined threshold value.

(Supplementary Note 6)

The action learning device according to any one of supplementary notes 2 to 5, wherein the correlation value is a likelihood related to the output value of the learning cell.

(Supplementary Note 7)

The action learning device according to supplementary note 6, wherein the likelihood is a ratio of the output value of the learning cell when the plurality of element values to the largest value of output of the learning cell in accordance with a weighting factor set for each of the plurality of input nodes are input.

(Supplementary Note 8)

The action learning device according to any one of supplementary notes 2 to 7 further comprising a situation information generation unit that, based on the environment and the situation of the subject, generates the situation information data in which information related to an action is mapped.

(Supplementary Note 9)

The action learning device according to supplementary note 1, wherein the score acquisition unit has a database that uses the situation information data as a key to provide the score for each of the plurality of action candidates.

(Supplementary Note 10)

The action learning device according to any one of supplementary notes 1 to 9, wherein when the environment and the situation of the subject satisfy a particular condition, the action selection unit performs a predetermined action in accordance with the particular condition with priority.

(Supplementary Note 11)

The action learning device according to supplementary note 10 further comprising a know-how generation unit that generates a list of know-how based on learning data of the score acquisition unit,

wherein the action selection unit selects the predetermined action in accordance with the particular condition from the list of know-how.

(Supplementary Note 12)

The action learning device according to supplementary note 9, wherein the know-how generation unit generates aggregated data by using co-occurrence of representation data based on the learning data and extracts the know-how from the aggregated data based on a score of the aggregated data.

(Supplementary Note 13)

An action learning method comprising steps of:

extracting a plurality of possible action candidates based on situation information data representing an environment and a situation of a subject;

acquiring a score that is an index representing an effect expected for a result caused by an action for each of the plurality of action candidates;

selecting an action candidate having the largest score from the plurality of action candidates; and

adjusting a value of the score linked to the selected action candidate based on a result of the selected action candidate being performed on the environment.

(Supplementary Note 14)

The action learning method according to supplementary note 13,

wherein in the step of acquiring, in a neural network unit having a plurality of learning cells each including a plurality of input nodes that perform predetermined weighting on each of a plurality of element values based on the situation information data and an output node that sums and outputs the plurality of weighted element values, wherein each of the plurality of learning cells has a predetermined score and is linked to any of the plurality of action candidates, the score of a learning cell having the largest correlation value between the plurality of element values and an output value of the learning cell out of the learning cells linked to each of the plurality of action candidates is set for a score of a corresponding action candidate,

wherein in the step of selecting, the action candidate having the largest score is selected from the plurality of action candidates, and

wherein in the step of adjusting, the score of the learning cell linked to the selected action candidate is adjusted based on a result of the selected action candidate being performed.

(Supplementary Note 15)

The action learning method according to supplementary note 13, wherein in the step of acquiring, the score for each of the plurality of action candidates is acquired by using the situation information data as a key to search a database that provides the score for each of the plurality of action candidates.

(Supplementary Note 16)

The action learning method according to any one of supplementary notes 13 to 15, wherein in the step of selecting, a predetermined action in accordance with the particular condition with priority is performed when the environment and the situation of the subject satisfy a particular condition.

(Supplementary Note 17)

A program that causes a computer to function as:

unit configured to extract a plurality of possible action candidates based on situation information data representing an environment and a situation of a subject;

a unit configured to acquire a score that is an index representing an effect expected for a result caused by an action for each of the plurality of action candidates;

a unit configured to select an action candidate having the largest score from the plurality of action candidates; and

a unit configured to adjust a value of the score linked to the selected action candidate based on a result of the selected action candidate being performed on the environment.

(Supplementary Note 18)

The program according to supplementary note 17,

wherein the unit configured to acquire includes a neural network unit having a plurality of learning cells each including a plurality of input nodes that perform predetermined weighting on each of a plurality of element values based on the situation information data and an output node that sums and outputs the plurality of weighted element values,

wherein each of the plurality of learning cells has a predetermined score and is linked to any of the plurality of action candidates,

wherein the unit configured to acquire sets, for a score of a corresponding action candidate, the score of a learning cell having the largest correlation value between the plurality of element values and an output value of the learning cell out of the learning cells linked to each of the plurality of action candidates,

wherein the unit configured to select selects the action candidate having the largest score from the plurality of action candidates, and

wherein the unit configured to adjust adjusts the score of the learning cell linked to the selected action candidate based on a result of the selected action candidate being performed.

(Supplementary Note 19)

The program according to supplementary note 17, wherein the unit configured to acquire has a database that uses the situation information data as a key to provide the score for each of the plurality of action candidates.

(Supplementary Note 20)

The program according to any one of supplementary notes 17 to 19, wherein when the environment and the situation of the subject satisfy a particular condition, the unit configured to acquire performs a predetermined action in accordance with the particular condition with priority.

(Supplementary Note 21)

A computer readable storage medium storing the program according to any one of supplementary notes 17 to 20.

(Supplementary Note 22)

An action learning system comprising:

the action learning device according to any one of supplementary notes 1 to 12; and

an environment that is a target which the action learning device works on.

This application is based upon and claims the benefit of priorities from Japanese Patent Application No. 2018-110767, filed on Jun. 11, 2018 and Japanese Patent Application No. 2018-235204, filed on Dec. 17, 2018, the disclosures of which are incorporated herein in their entirety by reference.

### REFERENCE SIGNS LIST

10 . . . action candidate acquisition unit
20 . . . situation information generation unit
30 . . . score acquisition unit
40 . . . neural network unit
42, 44 . . . cell
46 . . . learning cell
50 . . . determination unit
60 . . . learning unit
62 . . . weight correction unit
64 . . . learning cell generation unit
70 . . . action selection unit
80 . . . score adjustment unit
90 . . . action proposal unit
92 . . . know-how generation unit
100 . . . action learning device
200 . . . environment
300 . . . CPU
302 . . . main storage unit
304 . . . communication unit
306 . . . input/output interface unit
308 . . . system bus
310 . . . output device
312 . . . input device
314 . . . storage device
400 . . . action learning system

What is claimed is:

1. An action learning device comprising:
an action candidate acquisition unit that extracts a plurality of possible action candidates based on situation information data representing an environment and a situation of a subject;
a score acquisition unit that acquires a score that is an index representing an effect expected for a result caused by an action for each of the plurality of action candidates;
an action selection unit that selects an action candidate having the largest score from the plurality of action candidates; and
a score adjustment unit that adjusts a value of the score linked to the selected action candidate based on a result of the selected action candidate being performed on the environment.

2. The action learning device according to claim 1,
wherein the score acquisition unit includes a neural network unit having a plurality of learning cells each including a plurality of input nodes that perform predetermined weighting on each of a plurality of element values based on the situation information data and an output node that sums and outputs the plurality of weighted element values,
wherein each of the plurality of learning cells has a predetermined score and is linked to any of the plurality of action candidates,
wherein the score acquisition unit sets, for a score of a corresponding action candidate, the score of a learning cell having the largest correlation value between the plurality of element values and an output value of the learning cell out of the learning cells linked to each of the plurality of action candidates,
wherein the action selection unit selects the action candidate having the largest score from the plurality of action candidates, and
wherein the score adjustment unit adjusts the score of the learning cell linked to the selected action candidate based on a result of the selected action candidate being performed.

3. The action learning device according to claim 2,
wherein the score acquisition unit further includes a learning unit that trains the neural network unit, and
wherein the learning unit updates weighting factors of the plurality of input nodes of the learning cell in accordance with an output value of the learning cell or adds a new learning cell in the neural network unit.

4. The action learning device according to claim 3, wherein the learning unit adds the new learning cell when a correlation value between the plurality of element values and an output value of the learning cell is less than a predetermined threshold value.

5. The action learning device according to claim 3, wherein the learning unit updates the weighting factors of the plurality of input nodes of the learning cell when a correlation value between the plurality of element values and an output value of the learning cell is greater than or equal to a predetermined threshold value.

6. The action learning device according to claim 2, wherein the correlation value is a likelihood related to the output value of the learning cell.

7. The action learning device according to claim 6, wherein the likelihood is a ratio of the output value of the learning cell when the plurality of element values to the largest value of output of the learning cell in accordance with a weighting factor set for each of the plurality of input nodes are input.

8. The action learning device according to claim 2 further comprising a situation information generation unit that, based on the environment and the situation of the subject, generates the situation information data in which information related to an action is mapped.

9. The action learning device according to claim 1, wherein the score acquisition unit has a database that uses the situation information data as a key to provide the score for each of the plurality of action candidates.

10. The action learning device according to claim 1, wherein when the environment and the situation of the subject satisfy a particular condition, the action selection unit performs a predetermined action in accordance with the particular condition with priority.

11. The action learning device according to claim 10 further comprising a know-how generation unit that generates a list of know-how based on learning data of the score acquisition unit,
wherein the action selection unit selects the predetermined action in accordance with the particular condition from the list of know-how.

12. The action learning device according to claim 9, wherein the know-how generation unit generates aggregated data by using co-occurrence of representation data based on the learning data and extracts the know-how from the aggregated data based on a score of the aggregated data.

13. An action learning method comprising:
extracting a plurality of possible action candidates based on situation information data representing an environment and a situation of a subject;
acquiring a score that is an index representing an effect expected for a result caused by an action for each of the plurality of action candidates;
selecting an action candidate having the largest score from the plurality of action candidates; and
adjusting a value of the score linked to the selected action candidate based on a result of the selected action candidate being performed on the environment.

14. The action learning method according to claim 13,
wherein in the acquiring, in a neural network unit having a plurality of learning cells each including a plurality of input nodes that perform predetermined weighting on each of a plurality of element values based on the situation information data and an output node that sums and outputs the plurality of weighted element values, wherein each of the plurality of learning cells has a predetermined score and is linked to any of the plurality of action candidates, the score of a learning cell having the largest correlation value between the plurality of element values and an output value of the learning cell out of the learning cells linked to each of the plurality of action candidates is set for a score of a corresponding action candidate,
wherein in the selecting, the action candidate having the largest score is selected from the plurality of action candidates, and
wherein in the adjusting, the score of the learning cell linked to the selected action candidate is adjusted based on a result of the selected action candidate being performed.

15. The action learning method according to claim 13, wherein in the acquiring, the score for each of the plurality of action candidates is acquired by using the situation information data as a key to search a database that provides the score for each of the plurality of action candidates.

16. The action learning method according to claim 13, wherein in the selecting, a predetermined action in accordance with the particular condition with priority is performed when the environment and the situation of the subject satisfy a particular condition.

17. A non-transitory computer readable storage medium storing a program that causes a computer to function as:
unit configured to extract a plurality of possible action candidates based on situation information data representing an environment and a situation of a subject;
a unit configured to acquire a score that is an index representing an effect expected for a result caused by an action for each of the plurality of action candidates;
a unit configured to select an action candidate having the largest score from the plurality of action candidates; and
a unit configured to adjust a value of the score linked to the selected action candidate based on a result of the selected action candidate being performed on the environment.

18. The non-transitory computer readable storage medium according to claim 17,
wherein the unit configured to acquire includes a neural network unit having a plurality of learning cells each including a plurality of input nodes that perform predetermined weighting on each of a plurality of element values based on the situation information data and an output node that sums and outputs the plurality of weighted element values,
wherein each of the plurality of learning cells has a predetermined score and is linked to any of the plurality of action candidates,
wherein the unit configured to acquire sets, for a score of a corresponding action candidate, the score of a learning cell having the largest correlation value between the plurality of element values and an output value of the learning cell out of the learning cells linked to each of the plurality of action candidates,
wherein the unit configured to select selects the action candidate having the largest score from the plurality of action candidates, and
wherein the unit configured to adjust adjusts the score of the learning cell linked to the selected action candidate based on a result of the selected action candidate being performed.

19. The non-transitory computer readable storage medium according to claim 17, wherein the unit configured to acquire has a database that uses the situation information data as a key to provide the score for each of the plurality of action candidates.

20.-21. (canceled)

22. An action learning system comprising:
the action learning device according to claim 1; and
an environment that is a target which the action learning device works on.
